(19) United States
(12) Patent Application Publication
(10) Pub. No.: US 2019/0101424 A1
(43) Pub. Date: Apr. 4, 2019

(54) THERMAL MASS FLOWMETER FOR LIQUIDS IN PARTIALLY FILLED PIPES

(71) Applicant: 2M Engineering Limited, Susteren Limburg (NL)

(72) Inventor: Henk Schar, Susteren Limburg (NL)

(21) Appl. No.: 16/148,395

(22) Filed: Oct. 1, 2018

Related U.S. Application Data
(60) Provisional application No. 62/566,713, filed on Oct. 2, 2017.

(51) Int. Cl. G01F 1/698; G01F 23/26

(52) U.S. Cl. CPC G01F 1/6986; G01F 23/265

(57) ABSTRACT

In order to measure water flow in sewer systems or other tubes, a sensor ring is inserted into a pipe with capacitive sensors at discrete levels along a circumference of the pipe. Speed is measured by heating up a resistor and measuring the rate at which heat is extracted from the resistor by the flowing liquid.

This application claims the benefit of U.S. provisional patent application Ser. No. 62/566,713, filed on Oct. 2, 2017, the contents of which are incorporated herein by reference in their entirety.

### BACKGROUND

Thermal mass flowmeters are mostly used in industry to measure flow in gas pipes. There are also versions for liquid but most such versions suffer from drawbacks, such as:

1. The pipe must be filled completely to accurately measure the flow. This is usually the case when measuring gasses and usually also with liquids.

2. The flow meter is physically obstructing the path of the medium in order to measure the flow.

In liquid pipes that also carry solids in the liquid flow, such as sewer pipes, conventional sensors are prone to clogging. Further, sewer pipes are typically not filled completely with liquid.

### BRIEF SUMMARY

A flow rate sensor for a pipe includes a stack of capacitive level sensors arranged at discrete levels along a circumference of the pipe, a flow speed sensor comprising a reference temperature sensor and a heated temperature sensor, and a circuit to regulate heating of the heated temperature sensor to maintain a constant temperature differential between a temperature of the reference sensor and a temperature of the heated temperature sensor.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a partially filled pipe 100 and liquid flow 102 in accordance with one embodiment.

FIG. 2 illustrates a flow sensor 200 in accordance with one embodiment.

FIG. 3 illustrates a flex PCB 300 in accordance with one embodiment.

FIG. 4 illustrates a pipe with flow sensing 400 in accordance with one embodiment.

### DETAILED DESCRIPTION

In order to measure water flow in sewer systems, a sensor ring is disclosed that is inserted into a sewer pipe and which is resistant to clogging and can withstand moderate grime buildup.

In one embodiment, speed is measured by heating up a resistor and measuring the rate at which heat is extracted from the resistor by the water. The faster the water flows, the faster the rate at which heat is lost.

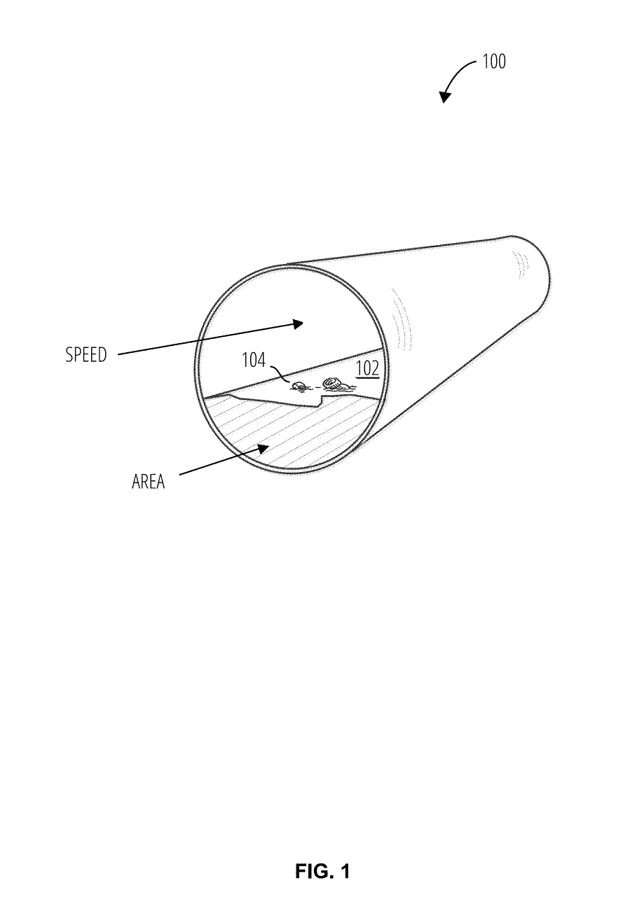

FIG. 1 illustrates a partially filled pipe 100 and liquid flow 102 in accordance with one embodiment. Solids 104 are borne along by the liquid flow 102.

In order to measure flow of the liquid flow 102 in the partially filled pipe 100, two values are measured: the speed of the liquid flow 102 and the height of the liquid flow 102 (from which the cross-sectional AREA of the flow can be determined). Multiplying AREA and speed yields flow rate. In the disclosed embodiments, both properties are measured with sensors embedded in a plastic sheet on one side of the pipe 100, without making electrical contact with the liquid flow 102 (see the following figures).

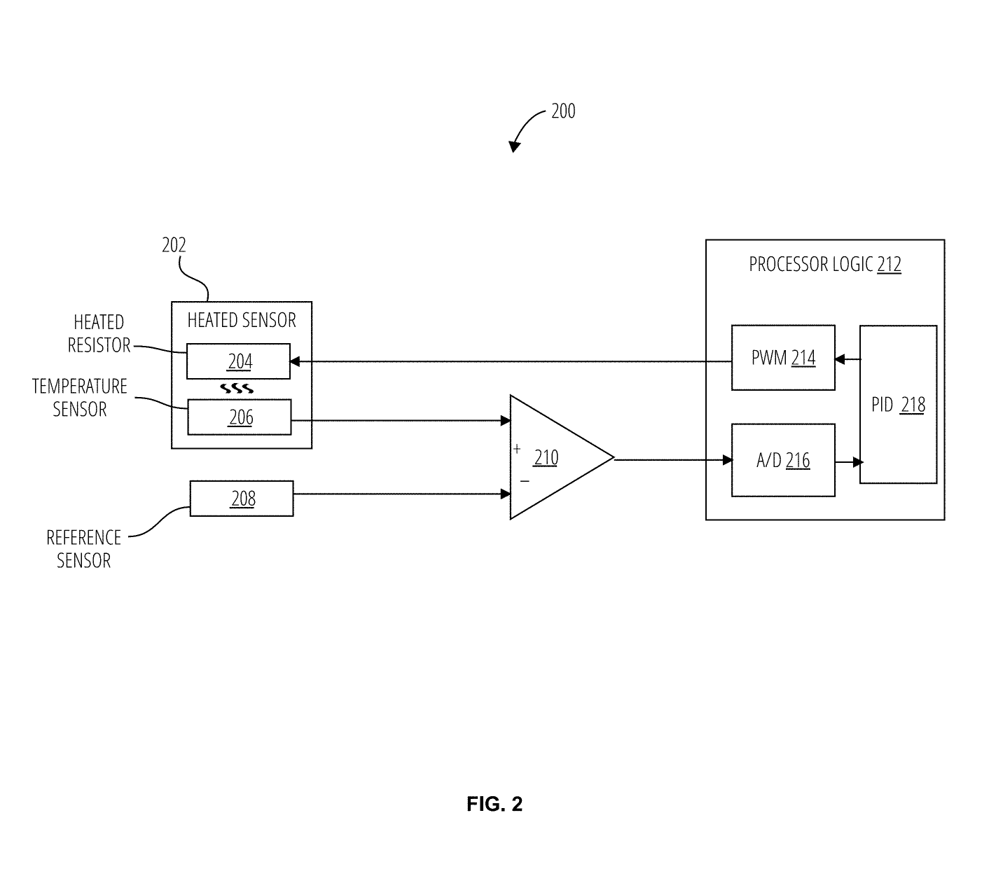

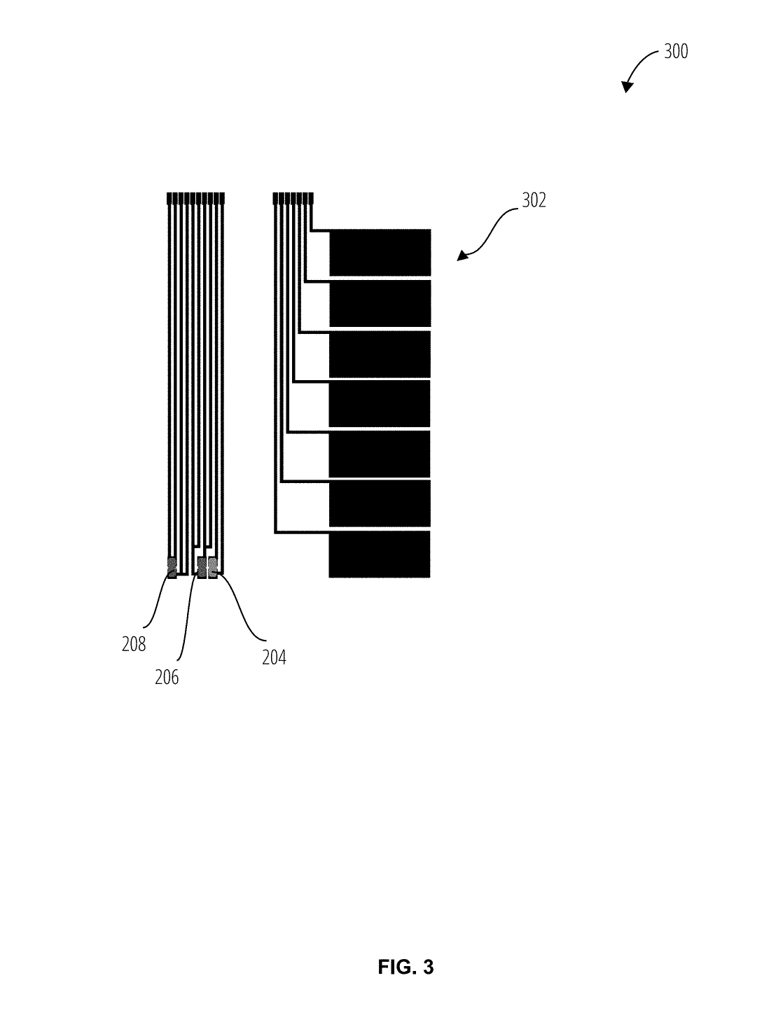

Referring to FIG. 2 through FIG. 4, a flow sensor 200 comprises a heated sensor 202, that includes a heated resistor 204 and a temperature sensor 206 influenced by thermal radiation from the heated resistor 204. A second reference temperature sensor 208 provides a reference signal. Outputs of the reference temperature sensor 208 and heat-influenced temperature sensor 206 are input to a differential amplifier 210, the output of which is provided to processor logic 212. The processor logic comprises a control loop using a pulse width modulator 214, an analog-to-digital converter 216, and proportional-integral-derivative logic (PID logic 218).

The outputs of the temperature sensor 206 and the reference temperature sensor 208 are compared by the differential amplifier 210, and the difference is converted to a digital electrical representation and processed by the PID logic 218 to maintain a constant temperature differential between the reference temperature sensor 208 and the temperature sensor 206. The PID logic 218 operates the pulse width modulator 214 to heat the temperature sensor 206 in the heated sensor 202. The pulse width modulator 214 output signal is correlated to the speed of the liquid flow 102. A duty cycle of the pulse width modulator 214 output is measured to represent the flow rate. For example, 0% duty cycle provides no heating at all, 25% of the time on (75% off) heats at 25% capacity, 100% on is heating at maximum capacity. The duty cycle is set by the PID logic 218. Typically, a function (lookup-table) translates this percentage to a flow rate, and this table is derived empirically by experimentation as it depends on many different factors of the system. It is typically not a linear relationship.

The cross-sectional area of the liquid flow 102 is determined by measuring the height of the liquid flow 102 and calculating the area of the circle segment that it circumscribes in the pipe 100. The height of the liquid flow 102 is measured with a capacitive sensor stack 302 arranged along the circumference of one side of the pipe 100. The individual sensors of sensor stack 302 may be aligned horizontally (so that each flow level contacts only one element at the flow surface, or angled downward (e.g., so that a given flow level contacts two or more of the elements at the flow surface). The water changes the sensor capacitance, which is measured using known techniques such as integration time measurements. The capacitive sensor stack 302 is printed on a flexible printed circuit board (flex PCB 300) that has different sensor areas for discrete height increments of the liquid flow 102. Height is thus measured in discrete steps, but it is possible to measure the analog capacitance of each sensor to interpolate values in between the discrete measurement heights. A particular capacitive sensor outputs higher values if more flow (e.g., water) covers it. This should in principle make it possible to further sub-divide a segment for higher precision. One problem is that the signals from the capacitive sensors may vary substantially based on other circumstances besides flow height, such as temperature etc. It is possible to make a hybrid scheme that utilizes interpolation by comparing the values of completely covered sensor with the values of empty sensors.

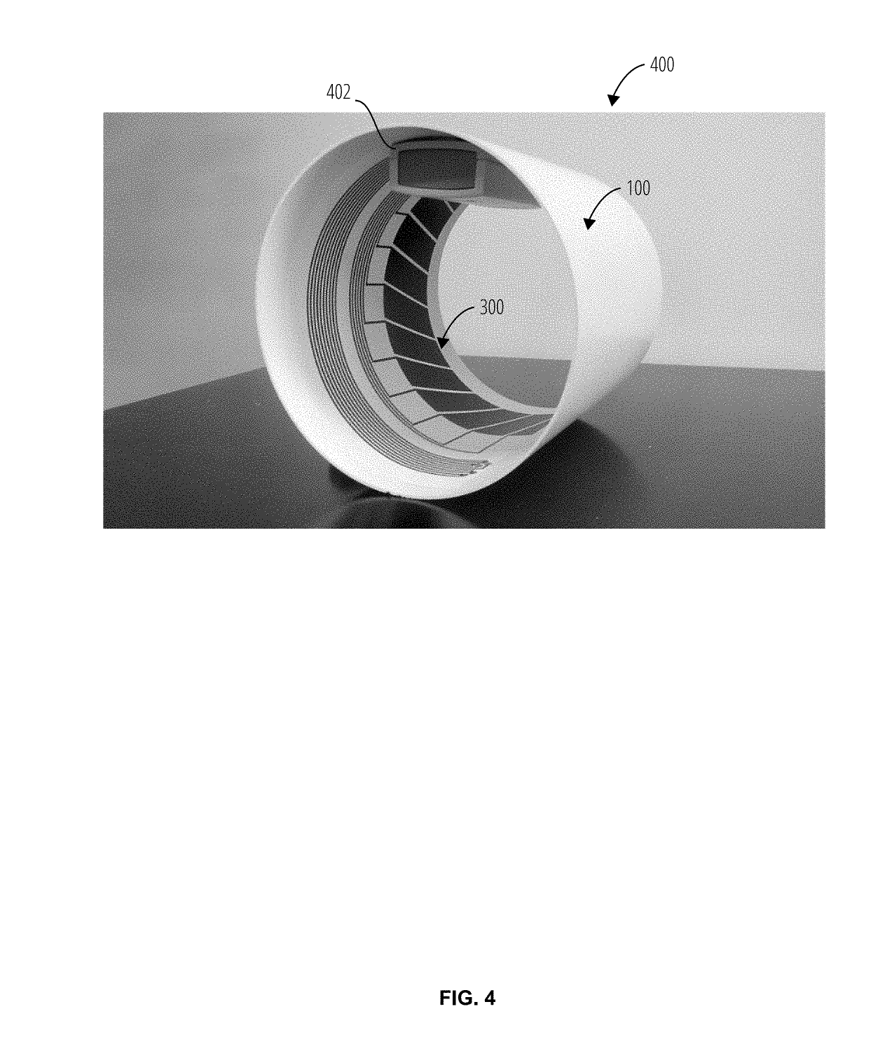

The layout of the flex PCB 300 includes circuits for both the capacitive and temperature sensing areas. In the pipe with flow sensing 400 of FIG. 4, a water proof housing 402 containing inter alia the flow sensor 200 and capacitance measurement logic may be fastened to the top of the pipe 100.

What is claimed is:

1. A flow rate sensor for a pipe, comprising:
a stack of capacitive level sensors arranged at discrete levels along a circumference of the pipe;
a flow speed sensor comprising a reference temperature sensor and a heated temperature sensor; and
a circuit to regulate heating of the heated temperature sensor to maintain a constant temperature differential between a temperature of the reference sensor and a temperature of the heated temperature sensor.
